(19) United States
(12) Patent Application Publication
(10) Pub. No.: US 2022/0067786 A1
(43) Pub. Date: Mar. 3, 2022

(54) SOCIAL MEDIA USER MONETIZATION SYSTEM, METHOD, AND ARCHITECTURE

(71) Applicant: Trenton Barron Austin, San Diego, CA (US)

(72) Inventor: Trenton Barron Austin, San Diego, CA (US)

(21) Appl. No.: 17/464,672

(22) Filed: Sep. 1, 2021

Related U.S. Application Data
(60) Provisional application No. 63/073,789, filed on Sep. 2, 2020.

(51) Int. Cl. G06Q 30/02

(52) U.S. Cl. CPC G06Q 30/0263; G06Q 30/0246; G06Q 30/0277

(57) ABSTRACT

Embodiments of architecture, systems, and methods that enable social media users to monetize their social media related activity and for advertisers to place ads on social media via social media users. Other embodiments may be described and claimed.

### TECHNICAL FIELD

Various embodiments described herein relate generally to architecture, systems, and methods used to enable social media users to monetize their social media related activity and for advertisers to place ads on social media via social media users.

### BACKGROUND INFORMATION

A social media user may want to monetize their social media related activity and advertisers may want to place ads on social media via social media users, the present invention provides architecture, systems, and methods to enable such activity.

### BRIEF DESCRIPTION OF THE DRAWINGS

FIG. 1 is a block diagram of a social media user monetization (SMUM) architecture according to various embodiments.

FIG. 2A is a diagram of communications between a social media (SM) User system, an advertiser system, a SM source system, a SMUM system, and a cloud-blockchain (CBC) system according to various embodiments.

FIG. 2B is a diagram of communications between a social media (SM) User system, a SM promotor system, a SM source system, a SMUM system, and a cloud-blockchain (CBC) system according to various embodiments.

FIG. 2C is a diagram of communications between a social media (SM) User system, an advertiser system, a SM source system, a SMUM system, and a payment system according to various embodiments.

FIG. 2D is a diagram of communications between a social media (SM) User system, a SM promotor system, a SM source system, a SMUM system, and a payment system according to various embodiments.

FIG. 3A is a block diagram of SMUM architecture communicating data to a main screen of an advertising or promotor system according to various embodiments.

FIG. 3B is a block diagram of SMUM architecture communicating data to a main screen of a SM User system according to various embodiments.

FIGS. 3C-3S are diagrams of screens of an advertising or promotor system according to various embodiments.

FIGS. 3T-3U are diagrams of screens of an SM User system according to various embodiments.

FIG. 4 is a block diagram of a SMUM system according to various embodiments.

FIGS. 5A-5B are flow diagrams illustrating several methods according to various embodiments.

FIG. 6 is a block diagram of an article according to various embodiments.

FIG. 7 is a block diagram of an article according to various embodiments.

### DETAILED DESCRIPTION

Users of social media sources such as Instagram, Facebook, Twitch, Twitter, Snapchat, Tik-Tok, LinkedIn, YouTube, Pintrest, and Tumblr may invest considerable time and expense to create their posts. SM Users may have followers that check their posts and may be termed influencers. Their number of followers may determine their level of influence. SM Users may also have an engagement rating which may represent the percentage of their followers that interact with the SM Users's posts.

In an embodiment a SM User's engagement rating may be a function of a number of social media metrics including:

A. The total number of likes a SM User has for their most recent post for a combination of their last X posts for a particular SM provider where X may be from 1 to 100 and about 30 in an embodiment;

B. The total number of comments a SM User posts has received for for their most recent post for a combination of their last X posts for the particular SM provider where X may be from 1 to 100 and about 30 in an embodiment;

C. The total number followers a SM User has currently or the maximum over a predetermine time frame, e.g. within the last 30 days for the particular SM provider; and

D. The current total number of posts a SM User has for the particular SM provider.

In an embodiment, the engagement rating for a User may be based on combination of factors A to D. In an embodiment, the engagement rating for a SM User may be equal AA times BB (AA*BB) where:

AA is equal to the sum of likes of a SM Users last 30 posts (e.g., post A1 has 2001 likes, post A2 has 4512 likes . . . post A30 has 6431 likes, the sum is equal to 2001+4512+ . . . +6431) divided by D—their total number of posts divided by C—their total number of followers; and

BB is equal to the B—the total number of comments a SM User's latest post received divided by D—their total number of posts divided by C—their total number of followers times 1.02.

Advertisers may want to increase the recognition of their brand, services, trademarks, and products via SM Users that have a certain SM performance metric such as the number of their followers or engagement rating or other metric as a function of the SM source. In an embodiment, a SM User may enable an advertiser to advertise on their social media source and an advertiser may compensate the SM User for their agreement to enable them to post as the SM User on a particular SM source where the posting type or format may vary on the SM source.

For example, Instagram® enables Users to post media including photos and videos. Other Instagram Users may follow a User to be informed when they post new media. Users can acknowledge a post by “liking” the post and posting comments about the post. In an embodiment, a SM User may enable an advertiser to post media on the SM User's Instagram account for a predetermined period of time in exchange for renumeration such as payment(s). The media may include an endorsement or other benefit to the advertiser. In exchange for the ability to post media a SM User's Instagram account for a predetermined period of time, an advertiser may compensate the SM User.

Another SM source such as Facebook®, that may be employed or used by an embodiment of the present invention. Facebook users have “friends” that may follow their activity. Their activity may include posting of text, instant messaging, photos, videos, and 3-D images and videos. Followers may “like” or give a thumbs up for a User's post. Content within media such as images may be “tagged”, the tag indicating another Facebook User or other identified information or data. A Facebook User may enable advertisements to be posted as content on their “page” or “timeline”.

Tumblr® is another example of a SM source that may be employed or used by an embodiment of the present invention. Tumblr users may post blogs which other Users via their dashboard may access. Tumblr users may follow the blogs or posts of other Users. Tumble Users may add tags to their posts or blogs to help other Users find their blogs. A Tumblr User may enable advertisements to be posted as part of their blog and may add tags related to advertisers or selected by advertisers.

Twitch® is another example of a SM source that may be employed or used by an embodiment of the present invention. Twitch streams live and previously recorded streams including gaming and non-gaming content such as creative content and sports. Users have followers that follow their streams. A Twitch User may incorporate advertisements, endorsements, or branding in a stream to be viewed by users.

Twitter® is another example of a SM source that may be employed or used by an embodiment of the present invention. Twitter Users can “tweet” short messages (280 or less characters) and audio and videos up to 140 seconds in length. Twitter Users can have followers that may automatically receive their new tweets or notifications of a new tweet. Twitter Users can tag other twitter accounts in their tweets. A Twitter User may enable advertisements to be posted as part of their tweets and may add tags related to advertisers or selected by advertisers.

Snapchat® is another example of a SM source that may be employed or used by an embodiment of the present invention. Snapchat Users can post multimedia messages “snaps” that have limited lifetimes, 24 hours in some cases. Snapchat Users can have followers that may automatically receive their new posts or notifications of a new post. A Snapchat User may enable advertisements to be posted as part of their snaps related to advertisers or selected by advertisers.

Tik-Tok® is another example of a SM source that may be employed or used by an embodiment of the present invention. Tik-Tok Users may make short videos, commonly to music provided or uploaded by the Users. Users have followers that follow their uploads. A Tik-Tok User may incorporate advertisements, endorsements, or branding in their video uploads to be viewed by users.

Another SM source Linkedin®, that may be employed or used by an embodiment of the present invention. Linkedin users have “connections” that may follow their activity. Their activity may include posting of text, messaging, photos, and videos. Connected Linkedin Users may view new posts by other connected Users. A Linkedin User may enable advertisements to be posted as content on their page.

Youtube® is another example of a SM source that may be employed or used by an embodiment of the present invention. Youtube Users may make or upload videos. Users may have followers that follow their uploads and other users may search for videos based on titles and content information. A Youtube User may incorporate advertisements, endorsements, or branding in their video uploads to be viewed by users.

Pintrest® is another example of a SM source that may be employed or used by an embodiment of the present invention. Pintrest Users can post multimedia messages “pins”. Pintrest Users can have followers that may automatically receive their new posts or notifications of a new post or pin. A Pintrest User may enable advertisements to be posted as part of their pins related to advertisers or selected by advertisers.

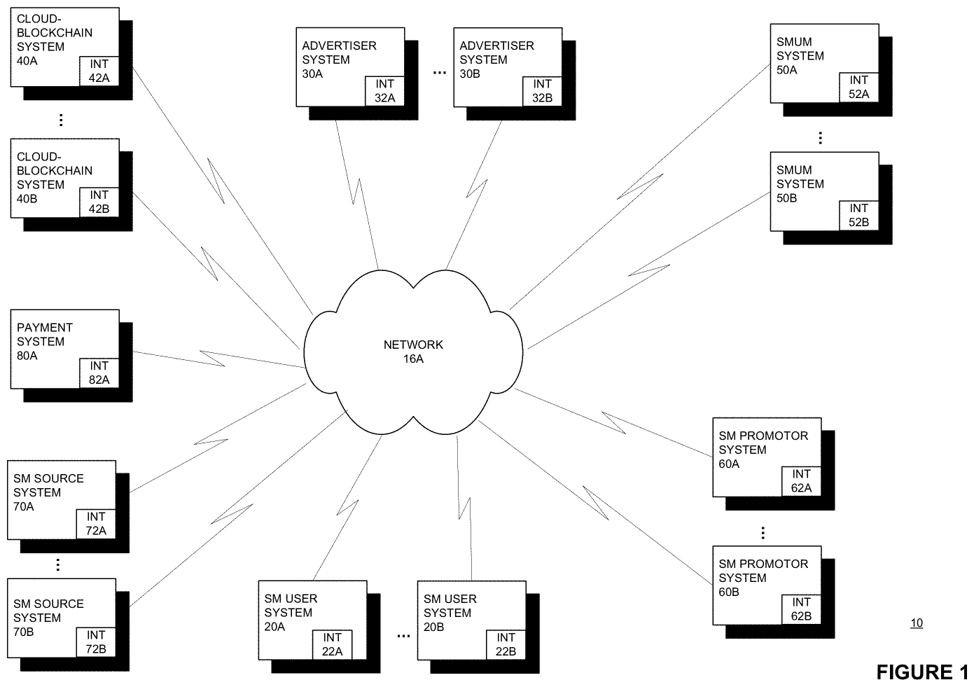

FIG. 1 is a block diagram of social media user monetization (SMUM) architecture 10 according to various embodiments. As shown in FIG. 1, SMUM architecture 10 may include a plurality of social media user systems (SMUS) 20A-20B, one or more advertiser systems (ADS) 30A-30B, one or more social media user monetization (SMUM) systems 50A-50B, one or more cloud-blockchain systems (CBCS) 40A-40B, one or more social media promotor systems 60A-60B (SNIPS), one or more social media source systems (SMSS) 70A-70B, and one or more payment systems 80A.

In an embodiment, the CBCS 40A-40B may include certificate authority entities that create or issue digital certificates. In an embodiment, the CBCS 40A-40B may employ cryptographically linked blocks in an open, distributed ledger termed blockchains and hereinafter systems 40A-40B are referred to as CBCSs although they could be any cryptographic provider, system, software, or entity and provide cloud services.

In an embodiment, an SMUS 20A-20B, ADS 30A-30B, CBCS 40A-40B, SMPS 60A-60B, SMSS 70A-70B, and payment system 80A may communicate with a SMUM system 50A-50B via one or more networks 16A where the networks may be local wired or wireless networks or a network of networks such as the Internet.

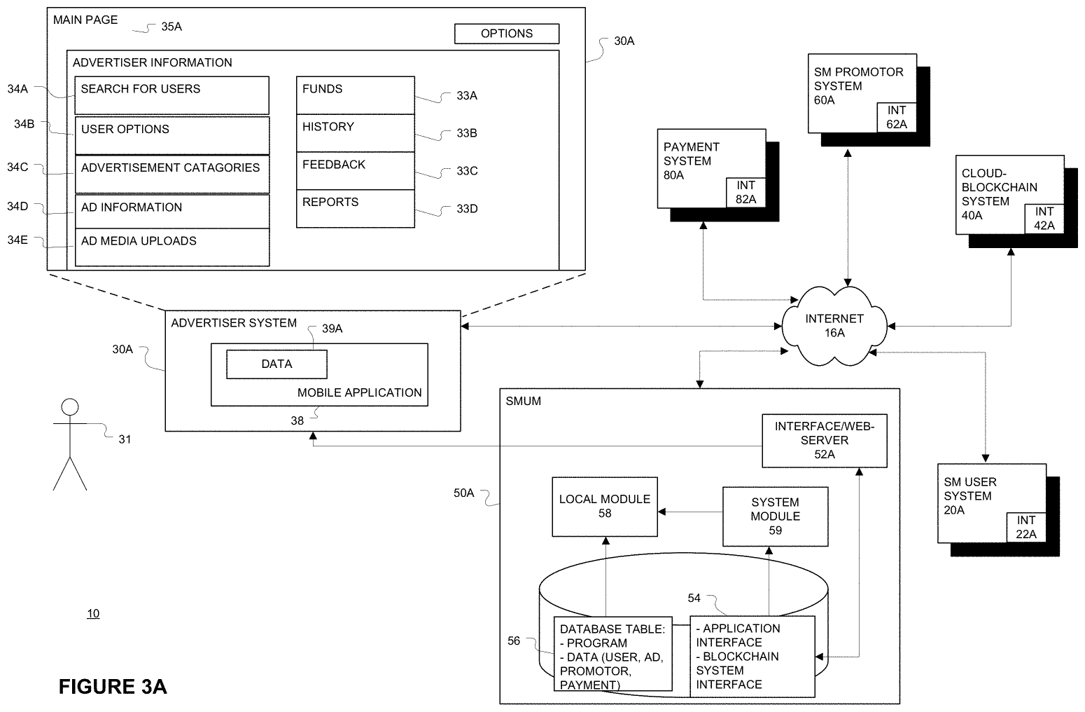

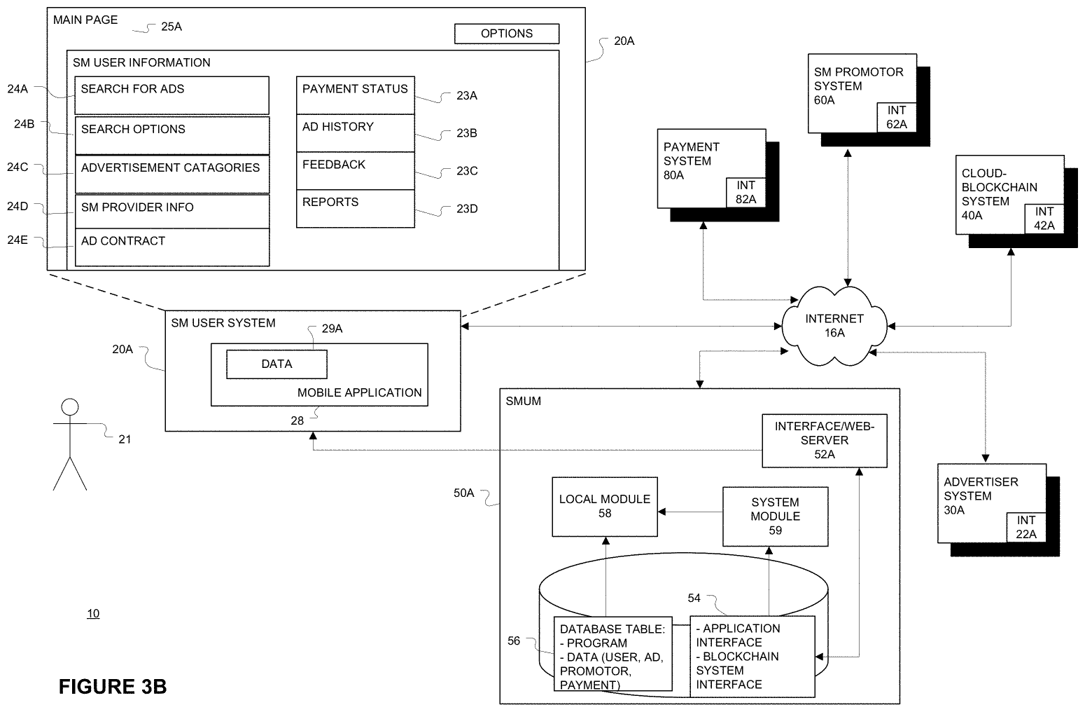

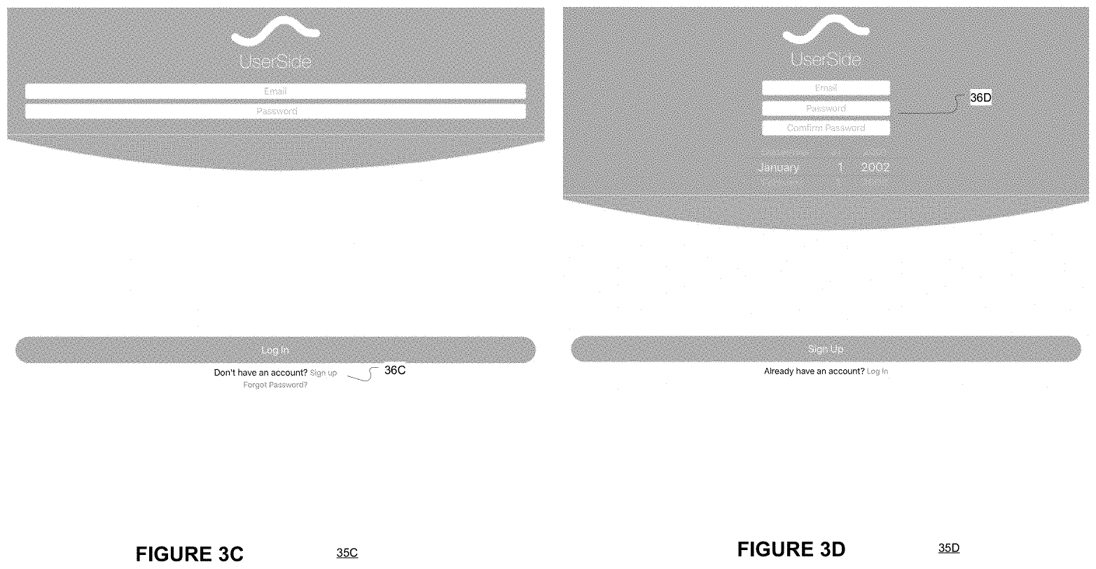

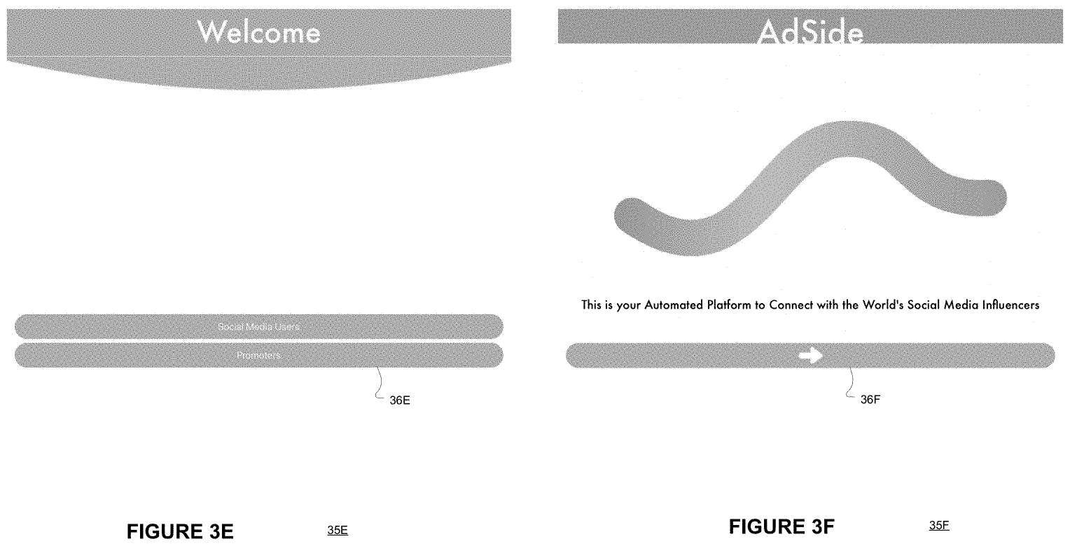

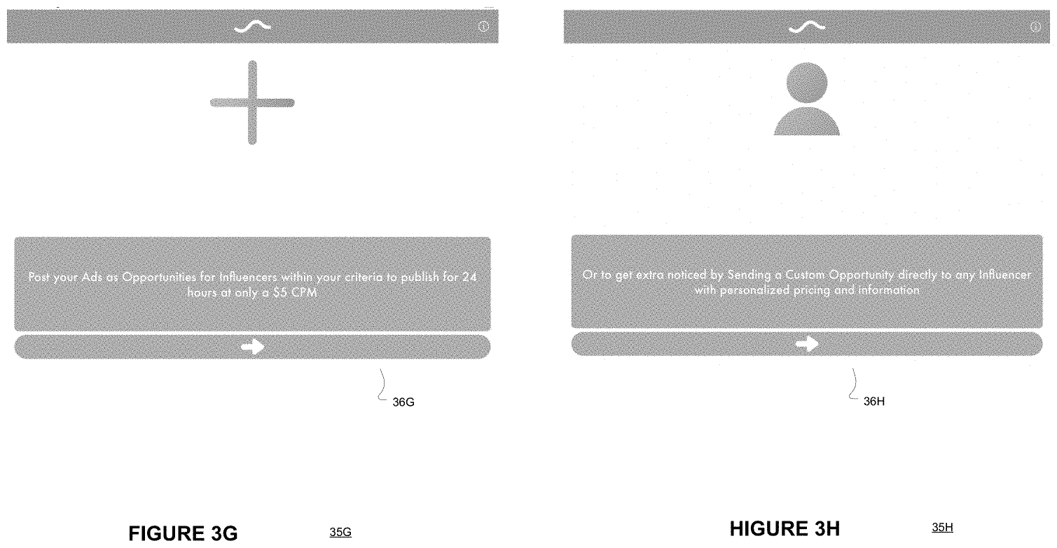

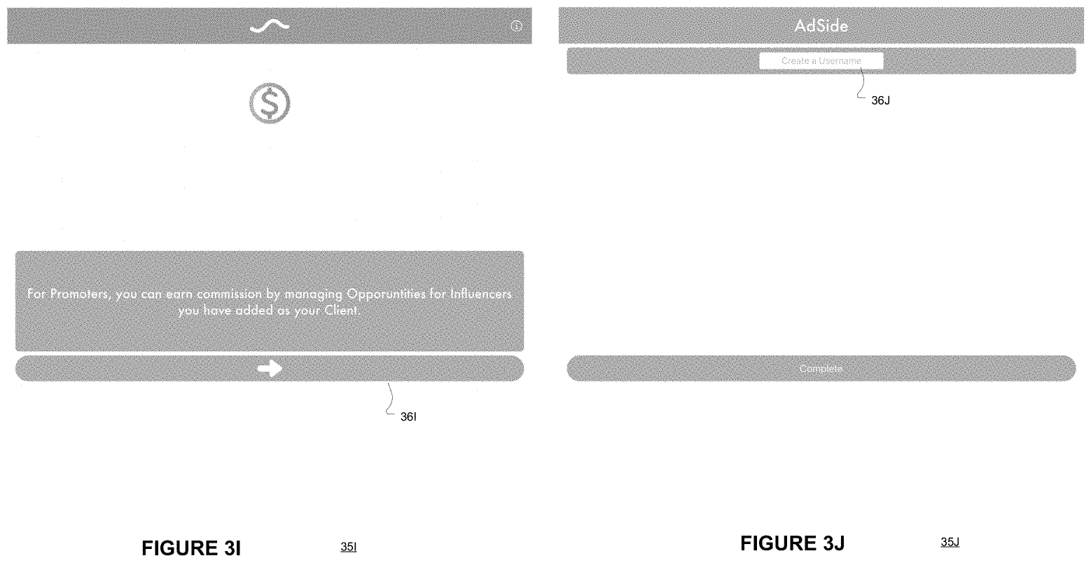

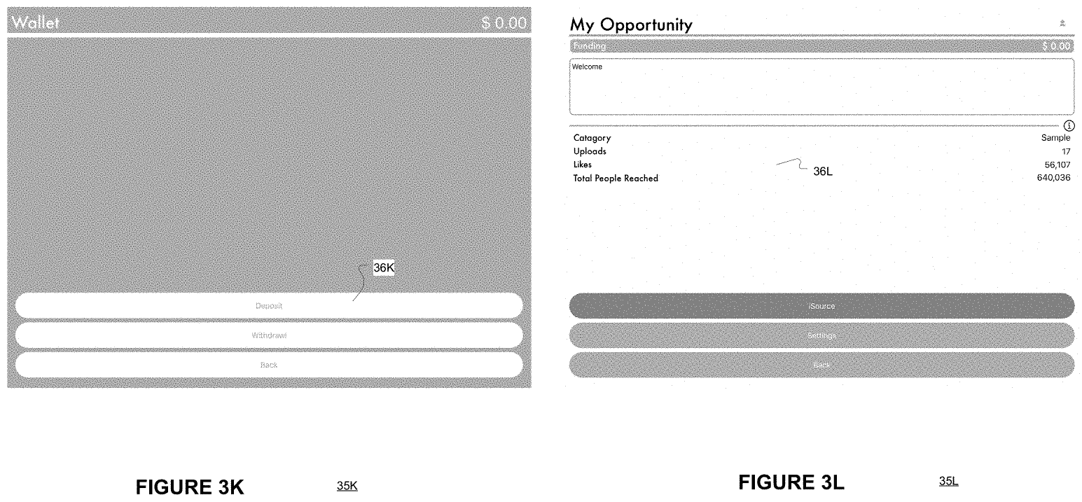

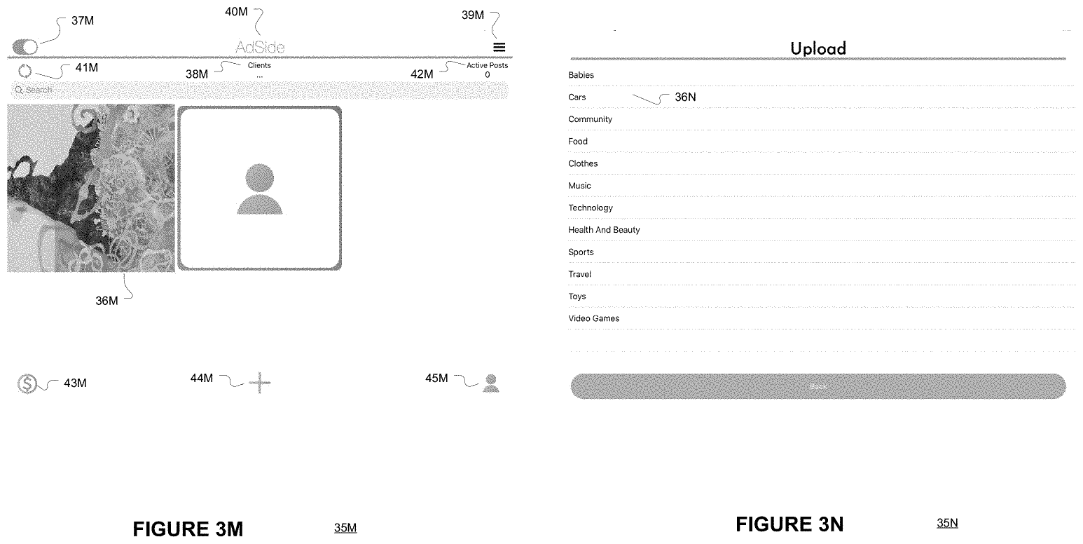

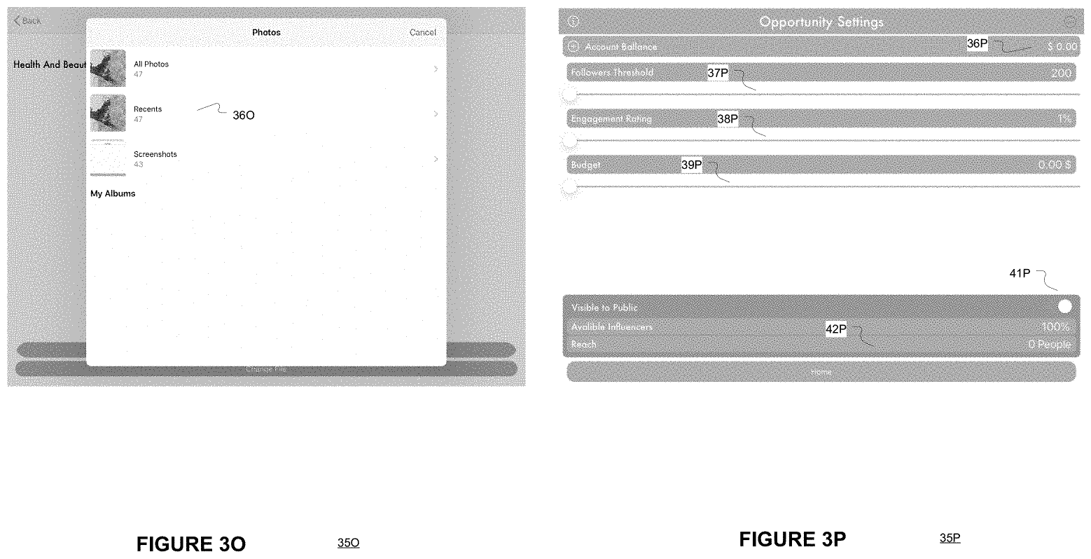

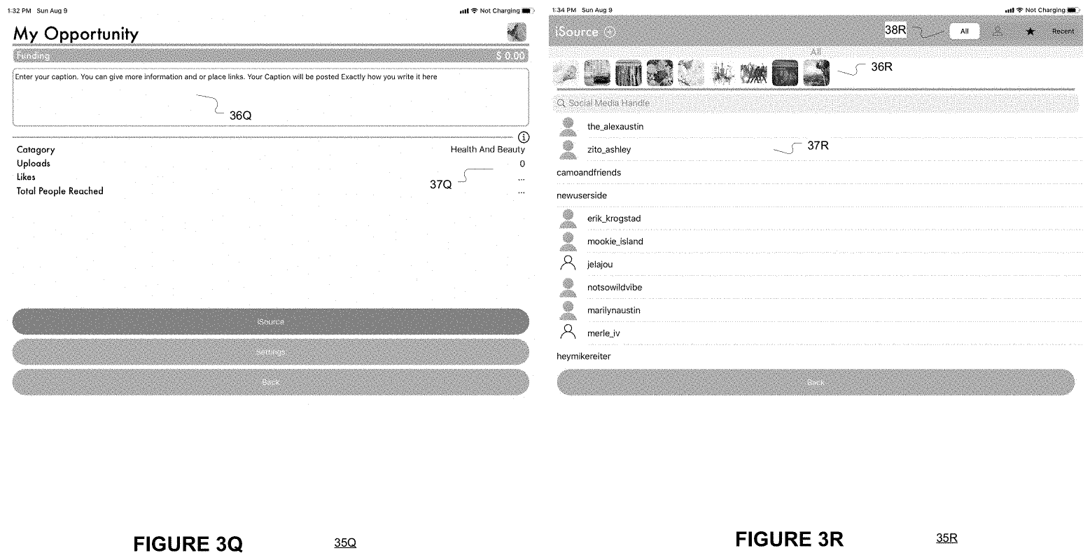

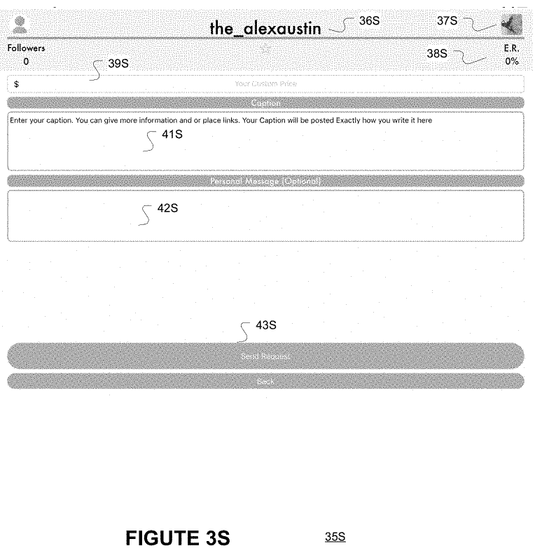

In an embodiment, a SM User via a social media user system—SMUS 20A-20B (hereinafter 20A for simplicity) via a local application, real-time application, or web-based interface (such as browser) may interact with a SMUM system 50A (such as via main user interface 25C in FIG. 3U). Similarly, an advertiser via an advertiser system—ADS 30A-30B (hereinafter 30A for simplicity) via a local application, real-time application, or web-based interface (such as browser) may interact with a SMUM system 50A (such as via main user interface 35M in FIG. 3M). A SM promotor via a social media promotor system—SMPS 60A-60B (hereinafter 80A for simplicity) via a local application, real-time application, or web-based interface (such as browser) may interact with a SMUM system 50A (such as via main user interface 35M in FIG. 3M).

In embodiment, a SM User via an SMUS 20A may search for advertising opportunities (opportunities) that an advertiser or promotor may have posted or created via architecture 10 to the User or Users that meet one or more criteria (such as via main user interface 25C in FIG. 3U option 23C, 24C). An advertiser via an ADS 30A and a SM promotor via an SMPS 60A may post advertising opportunities for a specific SM User or for consideration for SM Users that meet one or more criteria via architecture 10 (such as via main user interface 35M in FIG. 3M options 44M, 45M).

A SWUMS 50A may communicate with a payment system 80A (such as Stripe® or others) to forward payment information from an ADS 30A or SMPS 60A for posted activities. An advertiser may have a budget allocated for posted opportunities and may provide payment for the budget upfront or as opportunities are selected by SM Users (such as via opportunity settings interface 35P in FIG. 3P budget selection 39P). A payment system 80A may process payments (such as adding money to account balance (36P in FIG. 3P) from an advertiser including various forms of electronic payment including credit card, paypal, venmo, and bitcoin in an embodiment. A SMUMS 50A may direct a payment system 80A to make a payment to a SM User based on their activity in architecture 10 (such as a posted opportunity 28C show on a SM User main page 25C in FIG. 3U).

In an embodiment, a SMUMS 50A may communicate with a CBCS 40A to store SM User, advertiser, promotor, opportunities, payment, login, security, and other information in a blockchain. A SWUMS 50A may also communicate with a SM source system 70A to post an opportunity 28C in a SM User's account, to verify a SM User account posted opportunity 28C is still active, and that the SM User account is complaint with other agreements or regulations of accepted opportunities. In an embodiment, a SM User may provide their login information for the SM source system 70A to enable the SWUMS 50A to post activit(ies) based on the accepted opportunities (such as via user account interface 25B in FIG. 3T 26B). The CBCS 40A may be used to create tokens related to payment and store all related activity (such as opportunities—available and posted) using open, distributed ledgers, i.e., blockchains including SM source system 70A login information for SM Users.

In an embodiment, the CBCS 40A-40B (hereinafter 40A for simplicity) may employ cryptographically linked blocks in an open, distributed ledger termed blockchains in addition to digital certificates from cryptography certificate authority entities. A CBCS system 40A employing blockchains (hereinafter CBCS 40A for simplicity) may generate digital certificates, identifiers (IDs), or tokens than are unique and tied and copied/distributed to a plurality of systems 40A to secure the digital certificates, identifiers (IDs), tokens, SM User information, SM source login information for Users, advertiser information, promotor information, opportunities—available and posted, and payments. Similarly, in an embodiment any updates associated with architecture 10 such as the SM User information, SM source login information for Users, advertiser information, promotor information, opportunities—available and posted, and payments, may be distributed across many blockchain systems 40A to prevent corruption of SMUM architecture 10 data and provide a secure and reproducible record or ledger of all activity along with the source of such changes. In an embodiment, each SM User, SM source login information for Users, advertiser information, promotor information, opportunities—available and posted, and payments may be assigned a unique token that is created and stored by a CBCS 40A

In an embodiment as shown in FIGS. 3A and 3B, a SMUM system 50A may include an network interface/web-server/software server 52A where the server 52A may be configured to communicate messages, graphical user interfaces, virtual reality (VR), augmented reality (AR), software, data for applications on an advertiser system (ADS) 30A, social media user system (SMUS) 20A, social media promotor system (SMPS) 60A, CBCS 40A, and social media source system (SMSS) 70A via their interfaces 32A, 22A, 62A, 42A, and 72A.

In an embodiment, advertiser system (ADS) 30A, social media user system (SMUS) 20A, and social media promotor system (SMPS) 60A may host an application 28 and 38 including a web browser such as Internet Explorer, Safari, Netscape, Chrome, Firefox, or Opera, VR system, or AR system that may be configured to communicate messages and content with a SMUM system 50A.

In an embodiment, an advertiser system (ADS) 30A, social media user system (SMUS) 20A, social media promotor system (SMPS) 60A, CBCS 40A, and social media source system (SMSS) 70A via their interfaces 32A, 22A, 62A, 42A, and 72A may be any computer device capable of hosting an interface that can communicate with a SMUM system 50A including via web browser application 28, 38 runtime application, VR system, AR system, application programming interface (API), or other application as noted. An advertiser system (ADS) 30A, social media user system (SMUS) 20A, social media promotor system (SMPS) 60A, CBCS 40A, and social media source system (SMSS) 70A may include a processor with a network interface 32A, 22A, 62A, 42A, and 72A including a server, virtual server or system, personal computer, personal data assistant, cellular phone, video game console, or tablet computer.

In an embodiment, a SMUM system 50A may employ a web framework (WF) or web application framework (WAF) including Ruby on Rails, Java, Python, Apache, Django, or other software or architecture to provide web pages, framework, or wire frames to an advertiser system (ADS) 30A, social media user system (SMUS) 20A, and social media promotor system (SMPS) 60A. A SMUM system 50A may also employ Software as a Service (SaaS) to provide data and executable instructions to an advertiser system (ADS) 30A, social media user system (SMUS) 20A, and social media promotor system (SMPS) 60A webpages may be built using on a Rudy on Rails framework or other web frameworks. In an embodiment, an advertiser system (ADS) 30A, social media user system (SMUS) 20A, and social media promotor system (SMPS) 60A may host an application operating natively where the application communicates data with the SMUM system 50A (such as application downloaded from an application provider or provided by the SMUM system 50A).

An advertiser system (ADS) 30A, social media user system (SMUS) 20A, and social media promotor system (SMPS) 60A may use various operating systems including Microsoft operating systems (Windows), Linux, Mac OS X, Android, WEB OS, and others to run a SMUM system 50 interface program or web browser. In an embodiment, a SMUM system 50A may provide an interface application to run natively on an OSP system 20A. Such an interface may enable VR system, or AR systems to operate on an OSP system 20A.

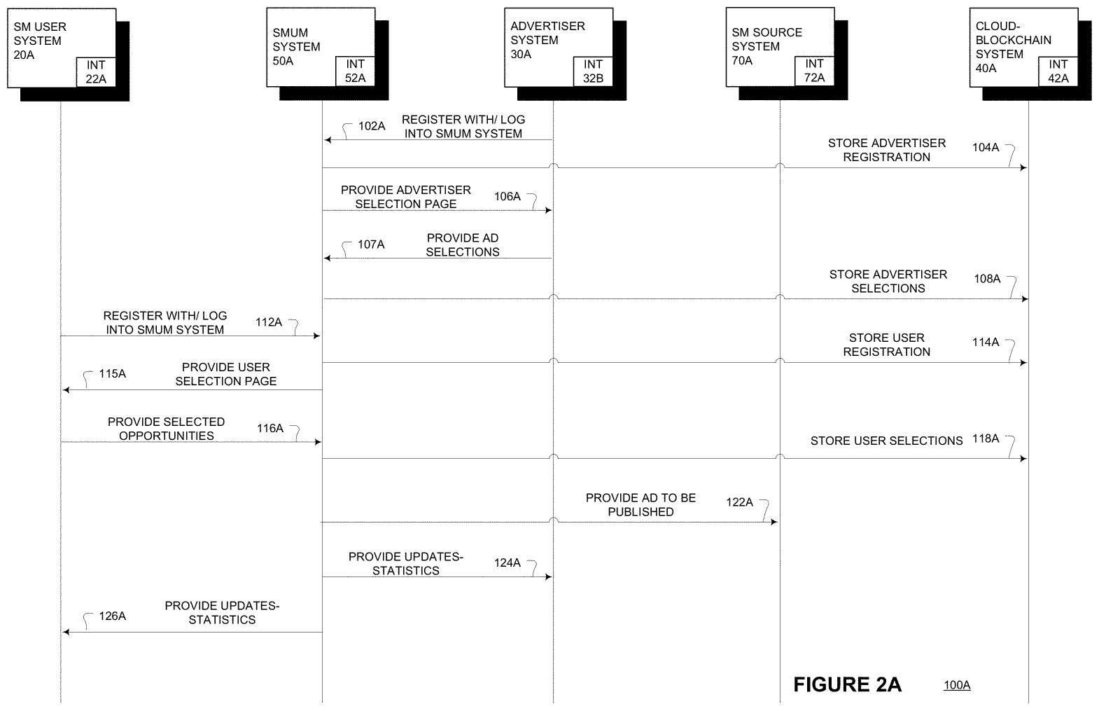

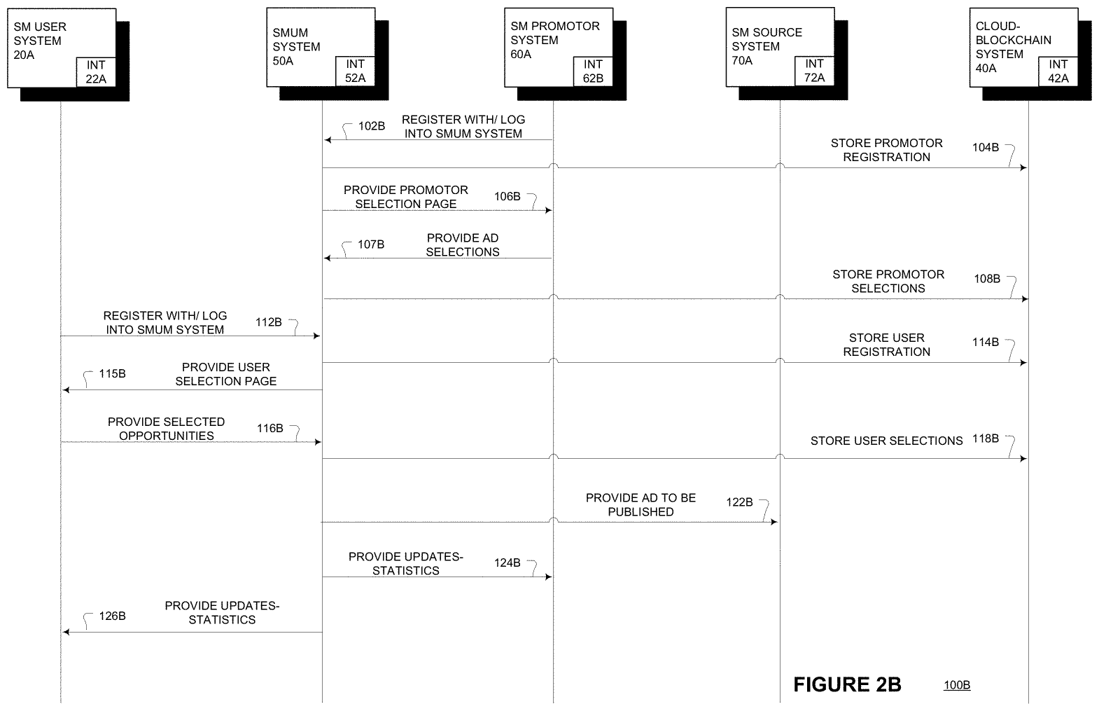

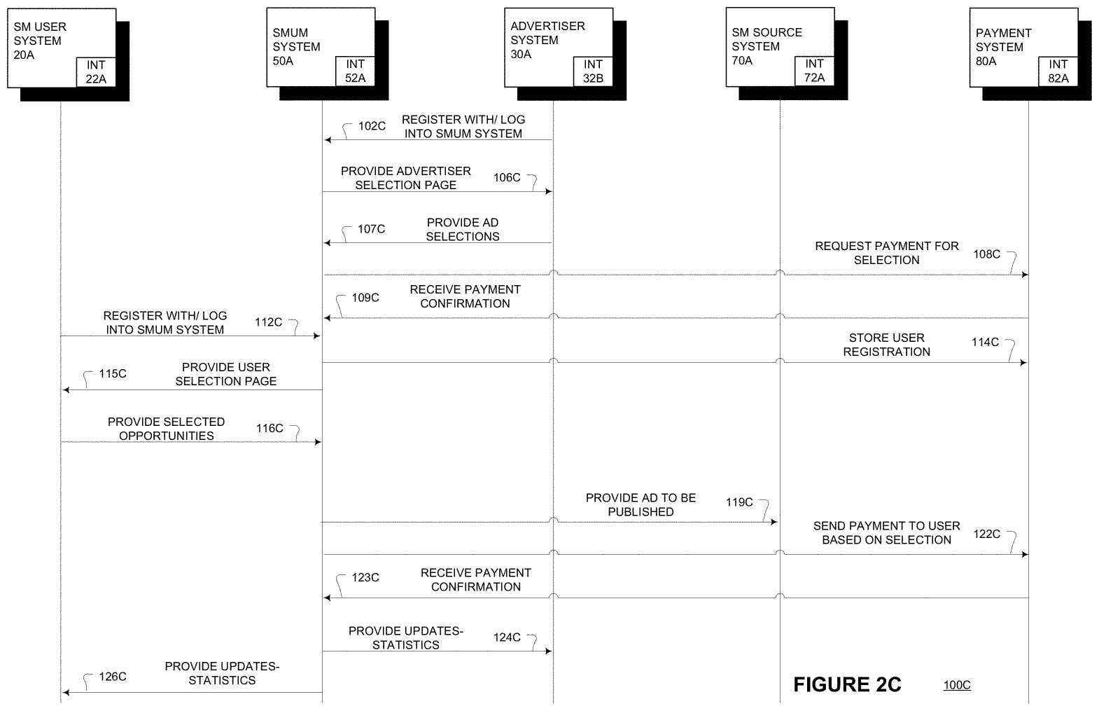

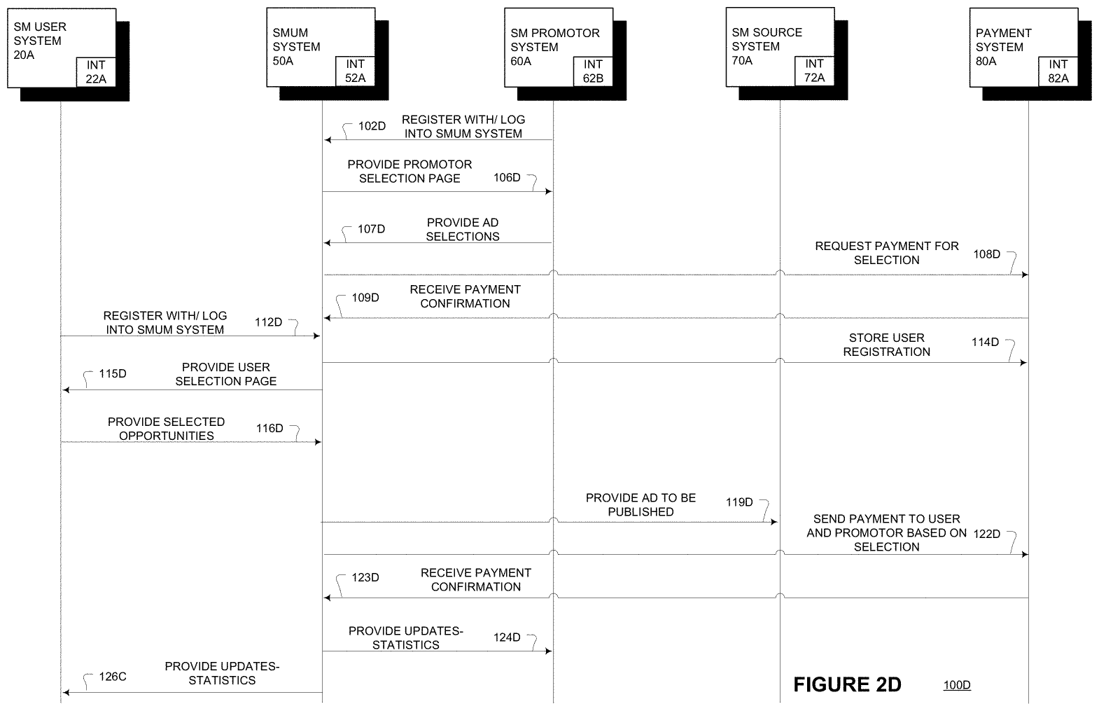

FIG. 2A is a diagram of communications between a social media (SM) User system 20A, an advertiser system 30A (or promotor system 60A), a SM source system 70A, a SMUM system 50A, and a cloud-blockchain (CBC) system 40A according to various embodiments. FIG. 2B is a diagram of communications between a social media (SM) User system 20A, a SM promotor system 60A, a SM source system 70A, a SMUM system 50A, and a cloud-blockchain (CBC) system 40A according to various embodiments. FIG. 2C is a diagram of communications between a social media (SM) User system 20A, an advertiser system 30A (or promotor system 60A), a SM source system 70A, a SMUM system 50A, and a payment system 80A according to various embodiments. FIG. 2D is a diagram of communications between a social media (SM) User system 20A, a SM promotor system 60A, a SM source system 50A, a SMUM system 50A, and a payment system 80A according to various embodiments.

In architecture 10, a SM user 21, an advertiser or promotor 31 may be required to register with/login to a SMUM 50A—communications 102A-D, 112A-D. FIG. 5A is a flow diagram illustrating a method 150A of registering a SM user 21, an advertiser or promotor 31 according to various embodiments. As shown in FIGS. 2A-2D and 5A, a SMUM system 50A may receive a registration/login request (communication 102A-D, 112A-D), activity 152A (such as via interfaces 35C and 35D selections 36C and 36D shown in FIGS. 3C and 3D, forward initial a SM user 21, an advertiser or promotor 31 information to a CBCS 40A for encrypted and distributed storage (communications 104A-D, 114A-D) and request a unique ID for the a SM user 21, an advertiser or promotor 31 (activity 154A).

This unique ID for a SM user 21, an advertiser or promotor 31 may allow them to create a secure history in the architecture 10 so other users may know their reputation as they use architecture 10 over time. In an embodiment, after initial registration, via interaction with the SMUM system 50A, a new applicant 21 or 31 may be able to state they are a SM user 21 or promotor/advertiser 31 (activity 156A and via interface 35E selection 36E shown in FIG. 3E. In an embodiment, an application or webpage for a SM user 21 may be called “Userside” and an application or webpage for a promotor/advertiser 31 may be called “Adside”.

In an embodiment, the unique ID or IDs for a SM user 21, an advertiser or promotor 31 may include one or more blockchain tokens that are uniquely and securely associated only with the SM user 21, the advertiser or promotor 31. The SMUM system 50A may receive and store the generated unique ID(s) or token(s) for the SM user 21, the advertiser or promotor 31 activity 156A.

Once registered, a SM user 21, an advertiser or promotor 31 may login into a SMUM system 50A via a social media user system (SMUS) 20A, an advertiser system (ADS) 30A, and a social media promotor system (SMPS) 60A thereafter using secured protocols. In an embodiment, a SM user 21, an advertiser or promotor 31 may be able to create a profile and add images to their profile via a social media user system (SMUS) 20A, an advertiser system (ADS) 30A, and a social media promotor system (SMPS) 60A.

Once registered or logged into a SMUM system 50A, a SMUM system 50A may generate and provide/forward a main page 25A, 35A (communications 106A-B, 115A-B) to a social media user system (SMUS) 20A, an advertiser system (ADS) 30A, and a social media promotor system (SMPS) 60A via a network 16, such as the graphical user interface screens 25A, 35B shown in architecture 10 in FIG. 3A and FIG. 3B and interface screens 25C, 35M shown in FIGS. 3U and 3M.

As shown in FIGS. 3A and 3B, a SMUM system 50A may include a network interface/web-server 52A, application interfaces and blockchain system interfaces/protocols 54, user, advertiser/promotor tables/databases 56, a local module 58, and a system module 59. The system module 59 may develop requests and processes responses from CBCSs 40A and payment system 80A. The local module 58 may interface with the user, advertiser/promotor table/database 56 and communicate data between the interface/webserver 52A and the database 56. The user, advertiser/promotor database 56 may include program data for the local module 58, system module 59, and interface/web-server 52A and systems 20A, 30A, 40A, 60A, and 80A and opportunity data.

The opportunity data may include unique ID(s) created for the advertiser created opportunity data and SM user posted opportunity data information. The application interfaces and blockchain system interfaces/protocols 54 may include data associated with interfacing with the CBCSs 40A and systems 20A, 30A, 40A, 60A, and 80A in an embodiment. As also shown in FIG. 3A, a main page 35A for an advertiser/promotor 31 as generated by a SMUM system 50A may include ability to search for particular SM users 34A and SM user options 34B (such SM presence, influence, activity, and other metrics such as engagement rating) (via interface 35R options 36R, 37R, 38R shown in FIG. 3R in an embodiment), category for opportunity (advertization) 34C (via interface 35N options 36N shown in FIG. 3N in an embodiment), AD or opportunity information 34D (via interfaces 35P, 35Q options 36P-41P and 36Q-37Q shown in FIGS. 3P and 3Q in an embodiment), AD or opportunity media (to be posted) 34E (via interface 35O option 36O shown in FIG. 3O in an embodiment), funds or banking information 33A (via interface 35K options 36K shown in FIG. 3K in an embodiment), history 33B, feedback 33C, and reports 33D (via interface 35L details 36L—shown in FIG. 3L in an embodiment).

As noted, once an applicant registers in architecture 10 via SMUM 50A, they may choose to use architecture 10 as a SM user 21 or an advertiser/promotor 31 via option 36E in interface 35E of FIG. 3E. Selection of operation as an advertiser/promotor 31 may generate initial information about using the system 50A for creating opportunities for posting by SM users 2, in an embodiment, initial information presented in interface 35F-351 in FIGS. 3F-31. For example, in an embodiment, an advertiser/promotor 31 may be charged a predetermined amount for a predetermined time interval as a function of the SM User's 21 number of followers. In an embodiment, an advertiser/promotor 31 may send an opportunity for review and possible posting to a specific SM User 21 or group of SM Users 21 that meet certain SM metrics such as number of followers, activity, engagement rating, interest in particular categories of activity or advertisements in an embodiment. In an embodiment, a promotor 31 acts on behalf of SM Users 21 by finding opportunities 28C for a SM User 21 for a portion of the fees to be paid to the SM user 21.

In an embodiment as shown in FIG. 3J, an advertiser/promotor 31 may create a username via option 36J of interface 35J of an application or webpage. An advertiser/promotor 31 may also create a company name. Their username and company name may be provided to SM Users 21 when they contact them in SMUM architecture 10. As shown in FIG. 3K, an advertiser/promotor 31 may add or withdrawal of funds to their account “wallet” via options 36K of interface 35K. An advertiser/promotor 31 may add funds to their account for funding opportunities to be potentially posted by SM users 21.

In an embodiment, after selecting a username or logging in once registered, an advertiser/promotor 31 main interface 35M as shown in FIG. 3M may be presented in an application or webpage of a system 30A or 60A. As shown in FIG. 3M, the main interface 35M provides several options/selections including the ability to view already listed opportunities 36M. By selecting already listed opportunities 36M, a system 30A, 60A may provide statistics 36L about the listed opportunity as shown in FIG. 3L interface 35L including the category, uploads by SM Users 21, likes (where the SM source provides such an indication), and total number of people reached (via the SM users 21 followers) in an embodiment.

In an embodiment, an application user can change their mode of operation from an advertiser/promotor 31 (Adside usage) to a SM user 21 (Userside) via toggle 37M. The current mode of operation 40M is shown in the interface 35M in an embodiment. Via option 38M, a promotor 31 may view the clients (SM Users 21) they represent. Via selection 39M, an advertiser/promotor 21 may view user settings. In an embodiment, option 41M enables an advertiser/promotor 21 to switch to a particular SM source to list an opportunity (such as intragram, facebook, . . . ). Option 42M may display metrics about active posts including SM metrics that may vary as a function of the SM source associated with the posts (listed opportunities that have been posted by a SM User 21). Option 43M may invoke the bank interface 35K shown in FIG. 3K in an embodiment. Selection of icon 44M may start the process of listing an opportunity in an embodiment (communications 106A-D of FIGS. 2A-2D). Listing an opportunity may include optionally selecting a category associated with the opportunity, uploaded media to be included with the opportunity, providing text and other data to be included with the opportunity, and the settings of the opportunity. The media, data, and settings may vary with the SM source 70A that will actually host the posted opportunity in an embodiment.

In an embodiment, the category to be associated with the listed opportunity 28C may be selected via interface 35N. As shown in FIG. 3N, there may be a predetermined number of categories that may be selected to be associated with the to be listed opportunity 28C in an embodiment. In an embodiment, multiple categories or a single category may be selected. The category selection(s) may enable SM Users 21 to more easily sort through opportunity listing based on their own interests.

A user 31 then may be able to select media (video, image, VR, AR) to be included in the listed opportunity (to be posted on the SM source system 70A) via an interface 35O shown in FIG. 3O via selection 36O in an embodiment. As shown in FIG. 3O, an image may be selected for the associated media(s). As noted, the possible associated media may be limited or determined by the SM source system 70A. A user (advertiser or promotor 31) may then configure the parameters for the proposed to be listed opportunity, which may also vary as a function of the SM source system 70A. An interface 35P shown in FIG. 3P may provide various parameters or settings 37P-42P in an embodiment. As shown in FIG. 3P, interface 35P may show the current account balance 36P for the user 31 and enable a user 31 to specify the budget via slider 39P to be allocated for the opportunity listing from the account balance 36P. Via the interface 35O, a user 31 may be able to select minimum SM metrics a SM User 21 may be required to meet in order to post the listed opportunity under their account on a SM source system 70A.

In an embodiment, the SM metrics may include a followers threshold 37P moving slider (to set minimum and maximum number of followers) and the engagement rating 38P moving slider (to set minimum and maximum engagement rating). Based on the selections, the number of potential SM users that may be permitted to post the opportunity in percentage and number may be calculated (section 42P). A user may also be able to prevent public viewing of the listing via toggle 41P. This may prevent a SM User or promotor from posting the opportunity until the user 31 is ready for its publication on a SM source system 70A or limit its viewing to users 21 that are contacted directly via icon 45M in interface 35M of FIG. 3M. A user may also be able to enter text or links to be included in the opportunity posting via interface 35Q window 36Q of FIG. 3Q. Interface 35Q may also include statistics 37Q about the listing. Once all the parameters, media, and text are selected, an opportunity 28C may be listed for possible posting by SM users 21 that meet the selected metrics or criteria (communications 107A-D).

As noted, a user 31 may create or list an opportunity 28C to be posted by only certain SM users 21. Via icon 45M in interface 35M of FIG. 3M and other locations in interfaces (denoted as Isource), a user 31 may invoke interface 35R shown in FIG. 3R to select particular SM users 21 that will eligible or permitted to post their opportunity. As shown in FIG. 3R, a user 31 may select the category 36R and SM users 37R. A user 31 may also be able to use toggles 38R to limit which SM Users 21 are presented for selection. In addition, the category selection 36R may also limit the SM users 21 presented (to those SM Users 21 that have indicated that they are interested or willing to post opportunities for certain categories in an embodiment.

A user 31 via interface 35S shown in FIG. 3S may be able to set a custom price 39S for the listing and selected SM users 21. The user 31 may also be able to enter text and links to be including in the posting 41S and a personal message 21 for the selected SM User(s) 21 prior to sending the request 43Q. In an embodiment, the links may include deep/tracking links specific to the SM User 21. Such links may enable sales and click analytics in SMUM architecture 10. In an embodiment, the opportunity settings may be stored in an a CBCS 40A (communications 108A-B). Payment via a payment system 80A may be made upon listing of opportunity 28C by a user 31 in an embodiment (communications 108C-D).

As noted, when a user registers with the system 50A (communications 112A-D) they may select the operational mode—advertiser (lister) or SM user (poster). When the user 21 select SM User 21, they may then next select the SM source that they are willing to possibly post opportunities via interface 25B selections 26B shown in FIG. 26B. Then a SM User 21 may view possible opportunities to post via interface 25C shown in FIG. 3U (communications 115A-D). As shown in FIG. 3U, a SM user 21 via interface 25C may be able to view opportunities 28C that they have currently posted in one or their accounts of a SM source system 50A. They may also be able to withdrawal funds in their account via the bank icon 29C and associated interface (similar to interface 35K shown in FIG. 3K.) They may view opportunities that are eligible to post via icon 23C and opportunities that are specifically directed to them via icon 24C.

In an embodiment, a SM User 21 may be able to search for particular opportunities based on one ore more criteria (activity 152B and communications 115A-D) and view the matching opportunities (activities 154B-158B). In an embodiment, SMUM system 50A may retrieve opportunities that the SM user 21 is eligible based on its criteria (such as certain SM metrics) (activity 154B), sort the retrieved opportunities based on the predetermined categories (activity 156B), and then present resultant opportunities with budget (activity 158B). In an embodiment, the categories may evolve via machine learning or artificial intelligence. In addition, a user 21, 31 may be able to create new categories or sub-categories.

If a SM User selects an opportunity (that they searched for or that was directed particularly to them (activity 162B) then the correlated budget of the advertiser 31 may be updated and the SM user 21 may be paid for the selection (communications 122C, 123C, 122D, 123D) (activity 174B) and store the SM user selections (communications 118A-B) in CBCS 40A. In an embodiment, the correlated budget of the advertiser 31 may be updated and the SM user 21 may be paid for the selection (communications 122C, 123C, 122D, 123D) (activity 174B) once the SM user 21 posts the selection (activity 172B) or the posting time is completed (activity 173B).

In an embodiment, a SM user 21 may need to request payment after the posting time is completed (check out). Then the SMUM system 50A or user 31 may verify that the SM user 21 did not violate any rules or policies prior to generating payment for the SM User 21 (activity 174B). The violations may include changing the AD (such as caption), not completing the minimum posting time, posting an uncomplimentary comment about the posted AD, and others in an embodiment.

In an embodiment, the selected opportunity may be formatted based on the SM user 21 and the particular SM source system 50A requirements (activity 166B). As noted, different SM source systems 50A may require particular media, media format, and text format. In addition, a SM user 21 may limit or specify certain aspects of the posting in an embodiment. Then the selected opportunity may be posted in the SM source system 50A (communications 122A-B, activity 172B). In an embodiment, the SM User 21 may only be paid for the posting once it has been posted for the agreed predetermined time interval (activities 173B, 174B). In an embodiment, the payment may be a function of the minimal posting time. Once published or posted, statistics related to its activity on the related SM source system 50A may be provided to the SM user system 20A, advertiser system 30A, and promoter system 60A (communications 124A-D and 126A-D).

In an embodiment, an advertiser 31 may post directly for a SM User 21 where the SM User 21 has granted the advertiser 31 permission to do so. In an embodiment, such an advertiser 31 is a “promotor” with “clients” that are SM Users 21 that have authorized them to post on their behalf. In an embodiment, a SM User 21 may provide a promotor 31 with a client code then enables the promotor 31 to add the SM User 21 to its list of clients. A SM User 21 can change their client status with a promotor 31 in the SMUM system 50.

A promotor 31 having one or more clients (SM users 21) may directly post an opportunity on the SM User's 21 SM provider 70 and complete other requirements (such as check out) so the client (SM User 21) is paid for the posted and completed opportunity. A promotor may receive a predetermined portion of the payment to the SM User 21 for their activity in an embodiment.

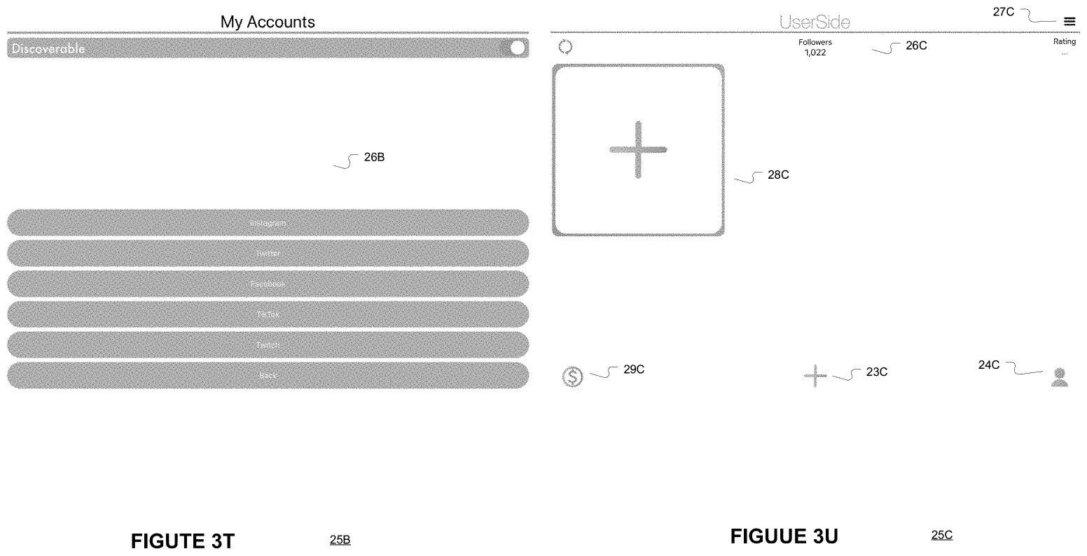

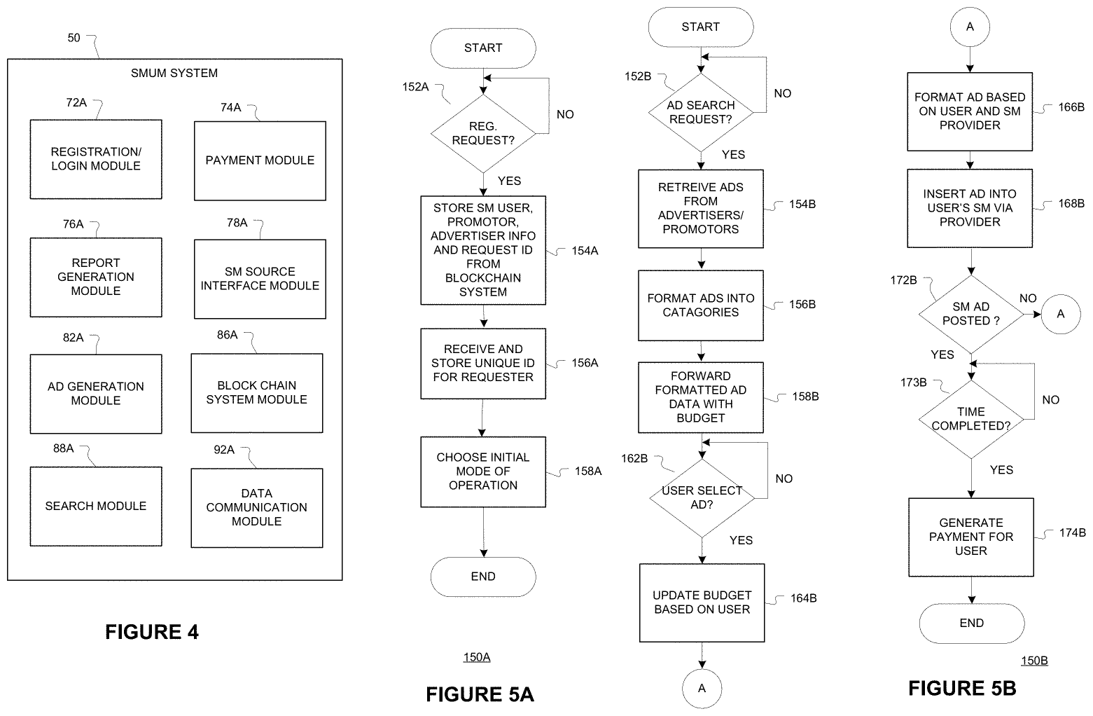

As shown in FIG. 4, a SMUM system may include a registration/login module 72A, a payment module 74A, a report generation module 76A, a SM source interface module 78A, an AD or opportunity generation module 82A, a block chain system module 86A, a search module 88A, and a data communication module 92A. The payment module 74A may interface with specific payment systems such as stripe or others. The SM source interface module 78A may include adapters or other protocols required to interface with a SM source system 50A. The block chain system module 86A may include an interface required to communicate with a cloud based blockchain system 40A.

In an embodiment, the databases 54, 56 may employ Greenplum (www.greenplum.com), Hadoop (hadoop.apache.org) HTTP Filer Server (HFS), PostgreSQL (www.postgresql.org) software, firebase (firebase.google.com), and other software and hardware to maintain the databases 54, 56. A SMUM system 50 may also store data on one or more cloud clusters or distributed systems. The data communication module may enable a SMUM system 50A to communicate over various networks using different protocols.

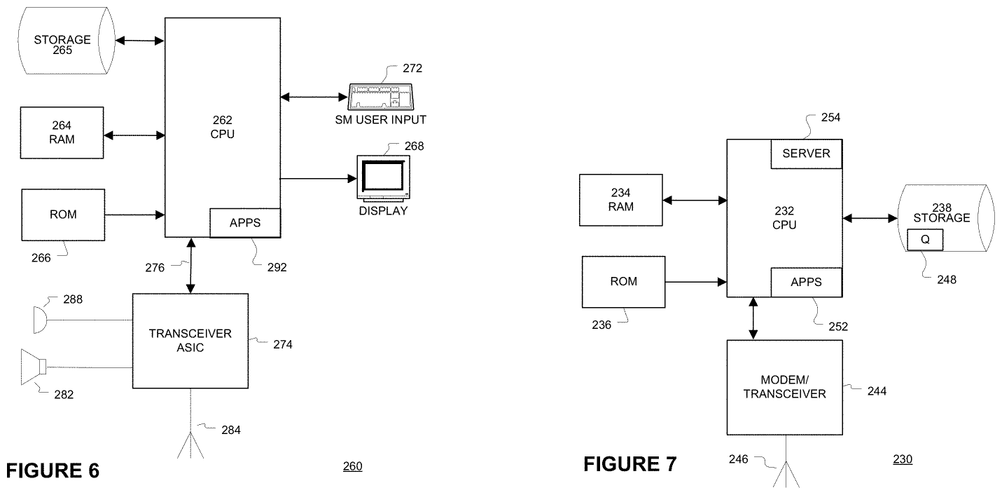

A device 260 is shown in FIG. 6 that may be used in various embodiments as a system 20A-B, 30A-B, and 60A-B. The device 260 may include a central processing unit (CPU) 262, a random-access memory (RAM) 264, a read only memory (ROM″) 266, a display 268, a user input device 272, a transceiver application specific integrated circuit (ASIC) 274, a microphone 288, a speaker 282, a storage unit 265, and an antenna 284. The CPU 262 may include an application module 292 including an application module 292. The RAM 264 may store SMUM system 50A provided content.

In an embodiment, the applications 292 may be a separate module. The application module 292 may process messages, displays, or pages from and generate messages, display, responses, or pages for the SMUM system 50A server 52. The storage 265 may store data provided by the SMUM system 50A server 52. The storage device 265 may comprise any convenient form of data storage and may be used to store temporary program information, queues, databases, and overhead information.

The ROM 266 may be coupled to the CPU 262 and may store the program instructions to be executed by the CPU 262, and the application module 292. The RAM 264 may be coupled to the CPU 262 and may store temporary program data, and overhead information. The user input device 272 may comprise an input device such as a keypad, touch screen, track ball or other similar input device that allows the user to navigate through menus, displays in order to operate the device 260. The display 268 may be an output device such as a CRT, LCD, touch screen, or other similar screen display that enables the user to read, view, or hear received messages, displays, or pages from the SMUM system 50A server 52.

A microphone 288 and a speaker 282 may be incorporated into the device 260. The microphone 288 and speaker 282 may also be separated from the device 260. Received data may be transmitted to the CPU 262 via a bus 276 where the data may include messages, displays, or pages received, messages, displays, or pages to be transmitted, or protocol information. The transceiver ASIC 274 may include an instruction set necessary to communicate messages, displays, or pages in architecture 10. The ASIC 274 may be coupled to the antenna 284 to communicate wireless messages, displays, or pages within the architecture 10. When a message is received by the transceiver ASIC 274, its corresponding data may be transferred to the CPU 262 via the bus 276. The data can include wireless protocol, overhead information, and pages and displays to be processed by the device 260 in accordance with the methods described herein.

FIG. 7 illustrates a block diagram of a device 230 that may be employed as a SMUM system 50A-B or CBCS 40A-B in various embodiments. The device 230 may include a CPU 232, a RAM 234, a ROM 236, a storage unit 238, a modem/transceiver 244, and an antenna 246. The CPU 232 may include a web-server 254 and application module 252. The RAM 234 may include a queue or database 248 where the database 248 may be used to store information including tenant, space provider, or space information, related data, and statistics. The storage 238 may also include a queue or database 256 where the database 256 may be used to store tenant, space provider, or space information. In an embodiment, the server 254 and the application module 252 may be separate elements. In an embodiment, the server 254 may generate content for web-pages or displays to be forwarded to an OSP system 20A.

The modem/transceiver 244 may couple, in a well-known manner, the device 230 to the network 16 to enable communication with a system 20A-B, 30A-B, and 60A-B. In an embodiment, the modem/transceiver 244 may be a wireless modem or other communication device that may enable communication with a system 20A-B, 30A-B, and 60A-B. The CPU 232 via the server 254 may direct communication between modem 244 and a an OSP system 20A or other systems 30A, 40A, 50A.

The ROM 236 may store program instructions to be executed by the CPU 232, server 254, or application module 252. The RAM 234 may be used to store temporary program information, queues, databases, and overhead information. The storage device 238 may comprise any convenient form of data storage and may be used to store temporary program information, queues, databases, and overhead information.

Any of the components previously described can be implemented in a number of ways, including embodiments in software. Any of the components previously described can be implemented in a number of ways, including embodiments in software. Thus, the CPU 232, server 254, application module 252, modem/transceiver 244, antenna 246, storage 238, RAM 234, ROM 236, database 248, database 256, CPU 262, application module 292, transceiver ASIC 274, antenna 284, microphone 288, speaker 282, ROM 266, RAM 264, database 267, user input 272, display 268, SMUM system 50A, CBCS 40A, system 20A-B, 30A-B, and 60A-B, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, video game consoles, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A social media user monetization (SMUM) method comprising:
receiving, by one or more processors, one of a plurality of social media (SM) advertising opportunities from a SM user's computing device, wherein the SM advertising opportunity is an advertisement to be published a page of the SM user on a SM source system; and
sending, by one or more processors, to the SM source system data representing an advertisement to be published a page of the SM user on the SM source system based on the selected one of a plurality of social media (SM) advertising opportunities.

2. The SMUM method of claim 1, wherein the SM advertising opportunity is integrating advertisement into a page of the SM User on the SM source system.

3. The SMUM method of claim 1, wherein the SM advertising opportunity is integrating advertisement into a home page of the SM User on the SM source system.

4. The SMUM method of claim 1, the plurality of social media (SM) advertising opportunities for a SM User are based on a SM performance metric of SM user on the SM source system.

5. The SMUM method of claim 1, wherein the SM performance metric includes one of the number of the SM user's followers and the SM user's engagement rating on the SM source.

6. The SMUM method of claim 2, wherein the SM source system hosts one of Instagram, Facebook, Twitch, Twitter, Snapchat, Tik-Tok, LinkedIn, YouTube, Pintrest, and Tumblr.

7. The SMUM method of claim 1, further comprising storing SM source system data representing an advertisement to be published a page of the SM user in cryptographically linked blocks in an open, distributed ledger.

8. The SMUM method of claim 6, wherein the SM source system data representing an advertisement to be published a page of the SM user may include one of video, image, virtual reality, or augmented reality-based media.

9. The SMUM method of claim 8, wherein the SM source system limits the media in an advertisement.

10. The SMUM method of claim 1, wherein SM source system data representing an advertisement to be published a page of the SM user may include tracking links specific to the SM User.

11. The SMUM method of claim 1, further comprising:
receiving, by one or more processors, a plurality of SM advertising opportunities from an advertiser's computing device; and
sending, by one or more processors, to a SM user's computing device data representing a plurality of social media (SM) advertising opportunities.

12. The SMUM method of claim 11, wherein the SM advertising opportunity is integrating advertisement into a page of the SM User on the SM source system.

13. The SMUM method of claim 11, wherein the SM advertising opportunity is integrating advertisement into a home page of the SM User on the SM source system.

14. The SMUM method of claim 11, the plurality of social media (SM) advertising opportunities for a SM User are based on a SM performance metric of SM user on the SM source system.

15. The SMUM method of claim 11, wherein the SM performance metric includes one of the number of the SM user's followers and the SM user's engagement rating on the SM source.

16. The SMUM method of claim 12, wherein the SM source system hosts one of Instagram, Facebook, Twitch, Twitter, Snapchat, Tik-Tok, LinkedIn, YouTube, Pintrest, and Tumblr.

17. The SMUM method of claim 11, further comprising storing SM source system data representing an advertisement to be published a page of the SM user in cryptographically linked blocks in an open, distributed ledger.

18. The SMUM method of claim 16, wherein the SM source system data representing an advertisement to be published a page of the SM user may include one of video, image, virtual reality, or augmented reality-based media.

19. The SMUM method of claim 18, wherein the SM source system limits the media in an advertisement.

20. The SMUM method of claim 11, wherein SM source system data representing an advertisement to be published a page of the SM user may include tracking links specific to the SM User.
